(19) United States
(12) Patent Application Publication
(10) Pub. No.: US 2018/0288214 A1
(43) Pub. Date: Oct. 4, 2018

(54) METHOD FOR OUTPUTTING MULTIMEDIA DATA AND CONTROL DEVICE THEREOF

(71) Applicant: Lenovo (Beijing) Co., Ltd., Beijing (CN)

(72) Inventors: Donghui LV, Beijing (CN); Lei WU, Beijing (CN); Zhiqiang ZHOU, Beijing (CN); Tianshui TAN, Beijing (CN)

(21) Appl. No.: 15/940,381

(22) Filed: Mar. 29, 2018

(30) Foreign Application Priority Data
Mar. 29, 2017 (CN) 201710198114.5

(51) Int. Cl. H04M 1/725; H04M 1/60

(52) U.S. Cl. CPC H04M 1/72569; H04M 2250/12; H04M 1/7253; H04M 1/6066

(57) ABSTRACT

The present disclosure provides a method for outputting multimedia data. The multimedia data are outputted through a first device. Responsive to detecting a posture change of a user, the multimedia data are outputted through a second device. The posture change of the user results in the second device being in a close proximity to the user than the first device.

### CROSS-REFERENCES TO RELATED APPLICATIONS

This application claims the priority of Chinese Patent Application No. 201710198114.5, entitled “Method for Outputting Multimedia Data and Control Device thereof”, filed on Mar. 29, 2017, the entire contents of which is incorporated herein by reference.

### FIELD OF THE DISCLOSURE

The present disclosure relates to the field of communication device technologies and, more particularly, relates to a method for outputting multimedia data based on Bluetooth communication and a control device thereof.

### BACKGROUND

With the continuous development of smart terminal technology and mobile phones, users rely more on mobile phones. Although mobile terminals have been able to change people's lives in many aspects with the improvement of the performance of hardware devices and network connections, the most commonly used function of the mobile phones is still the voice call function.

During a regular conversation, a user often places the mobile phone near his/her ear to receive or send the voice call. In some scenarios, it may not be convenient for the users to pick up and make regular calls. For example, the user may not hold the mobile phone with both hands. The traditional solution is to add a hand-free mode to the mobile phone, by operation on the mobile phone, to enable the user to switch the audio output externally to a speaker. Further, there is another solution to output audio via peripheral audio output devices, for instance, Bluetooth headsets and on-board Bluetooth output devices, which maintains the privacy of hands-free calls. However, during a call through a Bluetooth headset or an on-board Bluetooth device, call switches between the mobile phone and the on-board Bluetooth output device often also require a manual operation on the mobile phone, which is inconvenient and may affect call continuity and security.

The disclosed method and system are directed to solve one or more problems set forth above and other problems.

### BRIEF SUMMARY OF THE DISCLOSURE

In view of the drawbacks as stated above, one aspect of the present disclosure provides a method for outputting multimedia data. The multimedia data are outputted through a first device. Responsive to detecting a posture change of a user, the multimedia data are outputted through a second device. The posture change of the user results in the second device being in a close proximity to the user than the first device.

Another aspect of the present disclosure provides a control device for outputting multimedia data, which includes a processor and a sensor. The sensor is coupled to the processor and configured to detect a posture change of a user. Responsive to detecting the posture change of the user, the processor is configured to control output of the multimedia data from through a first device to through a second device. The posture change of the user results in the second device being in a closer proximity to the user than the first device.

Still another of the present disclosure provides a computer-readable storage medium. The computer-readable storage medium storing computer-executable instructions for execution by a processor to implement the disclosed method. A sensor is controlled to detect a posture change of a user. And responsive to detecting the posture change of the user, a processor is controlled to output multimedia data from through a first device to through a second device. The posture change of the user results in the second device being in a closer proximity to the user than the first device.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments, and are not intended to limit the scope of the present disclosure.

FIG. 1 is a flow diagram of a method for outputting multimedia data according to some embodiments of the present disclosure;

FIG. 2 is a flow diagram of a method for outputting the multimedia data to an output device according to some embodiments of the present disclosure;

FIG. 3 is a flow diagram of another method for outputting the multimedia data to an output device according to some embodiments of the present disclosure; and

FIG. 4 is a schematic structural diagram of a control device implementing a method for outputting multimedia data according to some embodiments of the present disclosure.

### DETAILED DESCRIPTION

Reference will now be made in detail to exemplary embodiments of the present disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which should be within the scope of the present disclosure.

When outputting multimedia files, each electronic terminal may have multiple output modes, such as outputting through a built-in play device, or outputting through an external multimedia device connected via an output interface. Bluetooth speakers, Bluetooth headsets, or on-board Bluetooth play devices that are widely used now may be connected to other multimedia devices or smart terminals for outputting multimedia data through Bluetooth connection. However, often users are required to perform a manual switch between these two output modes, which may cause inconveniences. Moreover, in a scenario of talking on a mobile phone when the user is driving, manual operations may cause a safety concerns. Accordingly, a main idea of the present disclosure is to detect posture change of the user with respect to a first device in real time, and to detect an output device for multimedia data associated in the first device in response to the posture change. As a result, the multimedia data are output through the output device. Embodiments of the present disclosure are described in detail below with reference to the accompanying drawings, which are provided for reference only. These embodiments are not intended to limit the present disclosure. The technical solutions provided by the present disclosure will be further described in detail with reference to the embodiments.

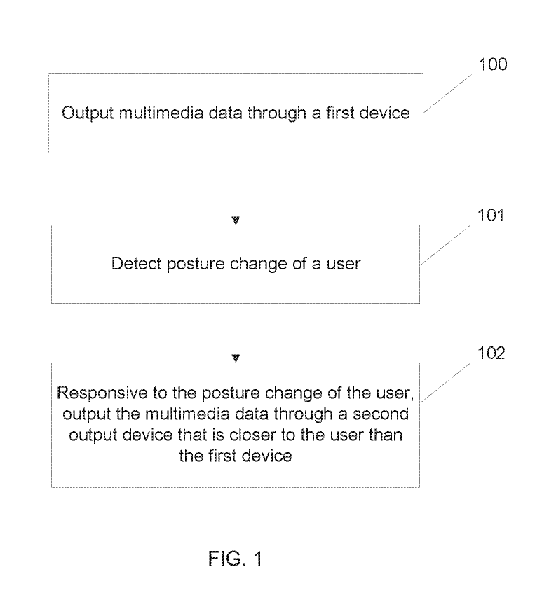

One aspect of the present disclosure provides a method for outputting multimedia data in a first device. In some embodiments, the first device may be a device that may output multimedia data, such as a mobile phone, a tablet, an MP3, an on-board computer, a wearable smart device, and the like. The first device may be connected to the second device which may include a Bluetooth speaker, a Bluetooth headset, or an on-board Bluetooth play device, and the like. When the second device is connected to the first device, and the first device outputs a multimedia file, the connected second device usually may output the multimedia file by default. Taking mobile phones as an example, during a call, if the Bluetooth headset is connected, and the user selects to answer the call, the mobile phone may output the multimedia audio by default through the Bluetooth headset. When the user forgets that the Bluetooth headset has been connected, or the Bluetooth headset is not worn, the user may pick up the call via the mobile phone as usual, but would not hear any sound. In this case, the conventional method often requires a manual user operation to disconnect the Bluetooth headset, or requires a manual selection to output by the receiver of the mobile phone. Depending on whether the user intends to use difference devices, it may result in many unnecessary operations. In order to solve this problem, after a multimedia output is intended to be performed, such as clicking a play button of an audio/video, or clicking a dial/pick-up button of the mobile phone, as shown in FIG. 1, the present disclosure provides a method for outputting multimedia data, which includes:

In 100: The multimedia data may be outputted through a first device.

In 101: A posture change of a user may be detected.

In some instances, detecting the posture change of the user may include the user's operations on the first device. The posture change herein may refer to a change in a user's posture in operating the first device, for example, picking up the mobile phone from the desk to place near his/her ear, or vice versa, moving the mobile phone away from his/her ear and placing it down on the desk, or shaking the mobile phone. It is apparent that the posture change may also include an operation on the first device, such as clicking, double-clicking, sliding, flipping, etc. In view of the above, in detecting the posture change of the user, the method may be implemented from two aspects.

First, a distance value between the first device and the user may be detected to determine the posture change of the user. This may be implemented by means of a sensor provided on the first device. For example, infrared sensors (distance sensors), light sensors, or front cameras that are used widely may be configured to detect the distance value between mobile phones and human faces. For instance, during a conversation call, when the mobile phone approaches a human face, the infrared sensor will determine that the mobile phone is close to the human face. In this condition, most of the mobile phones may turn off the screens or dim the screens at this moment to save electric power and give priority to completing the call. This may also protect the privacy of the user. In this example, when the sensor senses that the distance value between the first device and the human face satisfies a preset condition, the posture of the user is determined to have changed, and a multimedia output device of the first device may be accordingly determined.

Second, embodiments of the present disclosure further detect a posture change, which is to detect movement information of the first device to determine the posture change of the user. Still taking mobile phones as an example, when the mobile phone is operated, besides picking up the mobile phone to answer a call, there are usually other operations, such as putting down the mobile phone, flipping the mobile phone, and/or shaking the mobile phone, etc. The operations of the mobile phone may be detected by means of a gyroscope and an acceleration sensor, etc. The gyroscope can detect deflection angle of a device relative to a horizontal plane, such as turning a device. And the acceleration sensor can detect acceleration component of a device in all directions, such as movement information of picking up, putting down, and/or shaking a device.

In 102: Responsive to detecting the posture change of the user, the multimedia data may be outputted through a second device that is in a closer proximity to the user than the first device.

After detecting the posture change of the user, the technical solutions provided by the present disclosure may perform the following: responsive to the posture change, the multimedia data in the first device are outputted to the output device that is in a closer proximity to the user than the first device. If the posture change satisfies a condition, the multimedia data are outputted to one of the first device and second device communicatively connected with the first device. The condition herein may include for example: a change in the distance value satisfying a preset condition, the movement information satisfying a preset condition, the distance value and/or the movement information satisfying a preset condition.

In one example, if the posture change is the user picking up the first device near his/her ear, the output device may be the first device. And if the posture change is a posture change in which a distance between the first device and the user is not less than a first distance, the output device may be the second device that is in a closer proximity to the user.

In some examples, the second device may refer to another device communicatively connected to the first device. The output device, or the second device, of the first device may include a receiver and a speaker. In some embodiments, the receiver or the speaker may be used when outputting the multimedia data through the first device.

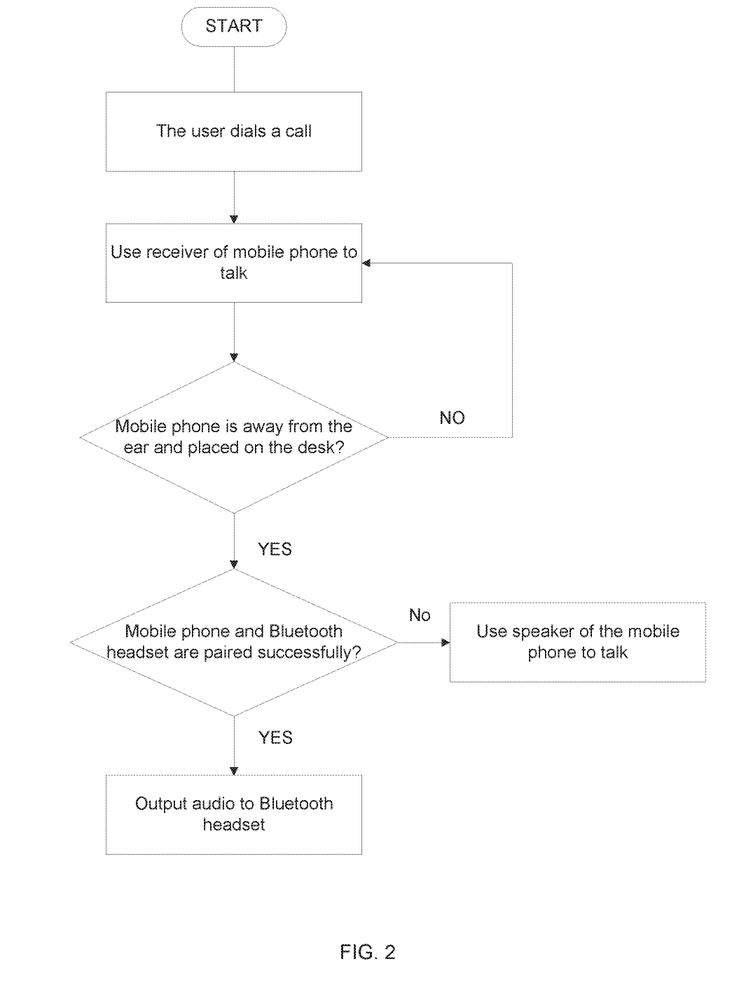

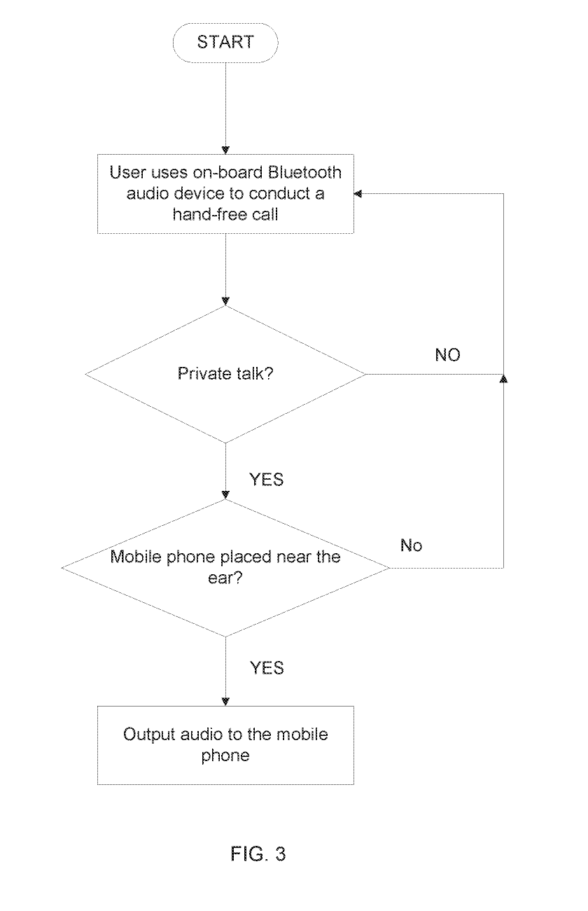

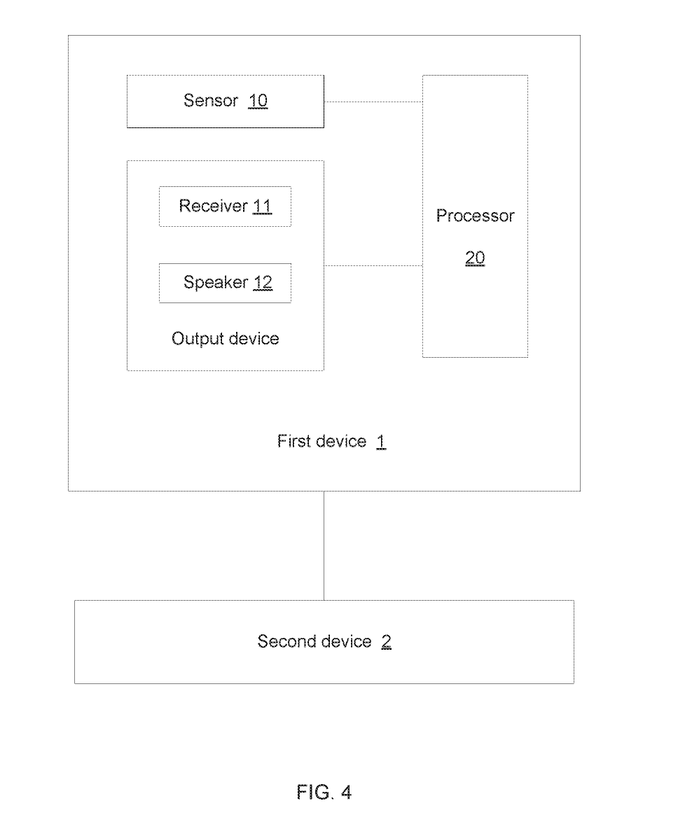

FIGS. 2 and 3 show flow diagrams of methods for outputting multimedia data according to some embodiments of the present disclosure. Use scenarios for the embodiments of the preset disclosure will be further described below with reference to FIGS. 3 and 4.

In one use scenario, the electronic device herein may refer to a mobile phone. As shown in FIG. 2, the user may hold the mobile phone to start a voice call, and a Bluetooth headset may be paired with the mobile phone. After the user dials a call, the mobile phone is placed on the desk. In this case, according to the method for outputting multimedia data provided by one embodiment of the present disclosure, a movement sensor and a position sensor of the mobile phone respectively may detect the posture change of the user and determine that the user has put the mobile phone on the desk. Further, a processor of the mobile phone may output the multimedia data in the mobile phone to, in response to the posture change, a Bluetooth headset. In this scenario, the second device, the Bluetooth headset, may be outputted by determining the posture change of the user, i.e. the mobile phone, to determine the user's intention about how to answer the call. During this process, the user does not need to perform a manual operation, so it does not affect the continuity of the call. This method can also be applied to social networking software that supports voice chat. For example, for the social networking software of WeChat, WhatsApp, line and other applications, in reference to the technical solutions provided by the present disclosure, the applications may be configured to automatically switch to the second device for outputting audio data. Embodiments of the present disclosure therefore enhances the user's experiences and the personal privacy is protected accordingly.

In another user scenario, still using mobile phones as an example, as shown in FIG. 3, when a user talks through an on-board Bluetooth audio device, and the conversation is being changed to have a private talk. In embodiments of the present disclosure, the user may only need to place the mobile phone near the ear to resume a private call. In this process, the gyroscope and the infrared sensor of the mobile phone respectively detect the posture change of the user. Further, the processor may output the multimedia data in the mobile phone to the receiver of the mobile phone, in response to the posture change. On the other hand, when the user is ready for a hand-free call again, and meanwhile, there is no second device communicatively connected with the first device, the user only needs to remove the mobile phone away from his/her ear. In this case, the movement sensor and the position sensor may detect the posture change of the user. Further, the processor may output the multimedia data in the mobile phone to the speaker of the mobile phone, in response to the posture change. In this scenario, the output device may be switched to the second device, and the user does not need to manually operate the entire switching process, and the consistency of the call is not affected.

In another scenario, still using mobile phones as an example, the user's mobile phone may be connected to a Bluetooth headset. After a long time has elapsed, the Bluetooth headset may no longer be worn on the ear of the user, but the connection remains. After the user clicks an incoming call button, he/she may pick up the mobile phone and get the mobile phone near his/her ear without the Bluetooth headset. In embodiments of the present disclosure, the user merely needs to get the mobile phone near the ear to conduct a normal conversation. In this process, the gyroscope and the infrared sensor respectively may detect the posture change of the user. Further, the processor may determine, in response to the posture change, to output the multimedia data to the receiver of the mobile phone.

Another aspect of the present disclosure provides a control device for multimedia data, i.e. the first device mentioned above. In some embodiments, the first device may be configured to output multimedia data, such as a mobile phone, a tablet, an MP3, an on-board computer, a wearable smart device, etc. And the first device may be connected to the second device. The second device may be a Bluetooth speaker, a Bluetooth headset, or an on-board Bluetooth play device, etc. When the second device is connected to the first device, and the first device outputs a multimedia file, the second device may output the multimedia file by default. Taking mobile phones as an example, during a call, if the Bluetooth headset is connected, and the user selects to answer the call, the mobile phone may output the multimedia audio by default through the Bluetooth headset. When the user forgets that the Bluetooth headset has been connected, or the Bluetooth headset is not worn, the user may pick up the call via the mobile phone as usual, but would not hear the sound. In this case, the conventional method requires a manual operation to disconnect the Bluetooth headset, or requires a manual selection to output by the receiver of the mobile phone. Depending on whether the user intends to use difference devices, the method may result in many unnecessary operations. In order to solve this problem, as shown in FIG. 4, the present disclosure provides a control device for multimedia data, comprising: a sensor 10 configured to detect posture change of a user with respect to the device 1; and a processor 20 configured to determine the multimedia data in the first device in response to the posture change of the user, and output the multimedia data through the output device.

In some embodiments, the sensor 10 may be configured to detect the posture change of the user. The method may include: detecting a distance value between the first device and the user. The posture change herein may refer to the posture change of the user in operating the first device, such as picking up the mobile phone to get near the ear from the desk, or vice versa, placing the mobile phone away from the ear on the desk, or shaking the mobile phone, etc. The above operations may be included as acceptable posture changes. Further, in some examples, the distance value between the first device and the user may be based on the posture change. Currently, the position sensor and the movement sensor may be used to realize the above-mentioned functions.

In some embodiments, the sensor 10 may be configured to detect the posture change of the user. The method may include: detecting movement information of the first device 1. The movement information may include the position change and the acceleration information of the first device 1 in space. Meanwhile, the position sensor may be further combined to determine the actual distance between the user and the first device 1.

After detecting the posture change of the user on the first device 1, the technical solutions provided by present disclosure is that the processor 20 may output the multimedia data in the first device 1 in response to the posture change. In some embodiments, the processor 20 may determine that, if the posture change satisfies a preset condition, one of the first device 1 and the second device 2 communicatively connected to the first device 1 may be outputted. In this case, the output device of the first device 1 may include a receiver 11 and a speaker 12. That is, the receiver 11 or the speaker 12 may be used for outputting the multimedia data when being outputted through the first device 1.

In the above embodiments, the sensor 10 may be configured to detect the posture change of the user. The sensor 10 may be configured to detect the movement information of the first device 1. This movement information may include the position change and the acceleration information of the first device 1 in space, which is achieved by the motion sensor or the acceleration sensor. The position sensor may be further combined to determine the actual distance between the user and the first device 1.

The above embodiments may further include a second device 2 communicatively connected to the first device 1. If the posture change satisfies a preset condition, the processor 20 may be configured to use one of the first device 1 and the second device 2 communicatively connected to the first device 1 as the output device. In this case, the output device of the first device 1 may include a receiver 11 and a speaker 12. The receiver 11 or the speaker 12 may be used to output the multimedia data when being outputted through the first device 1.

The method for outputting multimedia data and the control device according to the embodiments of the present disclosure may be implemented on a first device capable of outputting multimedia. In multimedia outputting, the posture change of the user may be detected, i.e. the posture change of the user in operating the first device. Further, the output device for the multimedia data in the first device may be outputted in response to the posture change. The multimedia data may be outputted through the output device. Therefore, embodiments of the present disclosure can adjust the output device in response to the posture change when the user uses the first device. Manual interventions by the user may be reduced. Especially for voice calls, technical problems that require manual operation intervention in switching the output device, poor call continuity, and poor security may be avoided.

It should be noted that the description of the foregoing embodiments of the electronic device may be similar to that of the foregoing method embodiments, and the device embodiments have the same beneficial effects as those of the method embodiments. Therefore, details may not be described herein again. For technical details not disclosed in the embodiments of the electronic device of the present disclosure, those skilled in the art may understand according to the method embodiments of the present disclosure.

In the several embodiments provided in the present disclosure, it should be understood that the disclosed device and method may be realized in other manners. The device embodiments described above are merely exemplary. For example, a unit division is merely a logical function division, and other divisions may exist in actual implementation. For example, multiple units or components may be combined, or may be integrated into another system. Some features may be ignored or not executed. Additionally, the coupling manners of the components illustrated or discussed may be a direct coupling or a communicative coupling. The coupling manners may be an indirect coupling or a communicative coupling through interfaces, devices, or units, which may be in electrical, mechanical or in other forms.

The units described above as separate components may or may not be physically separated. Components displayed as units may or may not be physical units, and may be located in one place or may be distributed to multiple network units. Some or all of the units may be selected according to actual needs to achieve the objectives of the solutions in the embodiments.

In addition, all functional units in the embodiments of the present disclosure may all be integrated in one processing unit, or each unit may be used as a single unit. Two or more units may be integrated in one. The above integrated unit can either be implemented in the form of hardware, or in the form of hardware combined with software functional units.

Persons of ordinary skill in the art should understand that, all or a part of steps of implementing the foregoing method embodiments may be implemented by related hardware of an instruction program. The instruction program may be stored in a computer-readable storage medium, and when executed, a processor executes the steps of the above method embodiments as stated above. The foregoing storage medium may include various types of storage media, such as a removable storage device, a read only memory (ROM), a random-access memory (RAM), a magnetic disk, or any media that stores program code.

Alternatively, when the above-mentioned integrated units of the present disclosure are implemented in the form of a software functional module being sold or used as an independent product, the integrated unit may also be stored in a computer-readable storage medium. Based on this understanding, the technical solutions provided by the embodiments of the present disclosure essentially or partially may be embodied in the form of a software product stored in a storage medium. The storage medium stores instructions which are executed by a computer device (which may be a personal computer, a server, a network device, or the like) to realize all or a part of the embodiments of the present disclosure. The above-mentioned storage medium may include various media capable of storing program codes, such as a removable storage device, a read only memory (ROM), a random-access memory (RAM), a magnetic disk, or an optical disk.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

The foregoing descriptions are merely embodiments of the present disclosure, and the protection scope of the present disclosure is not limited thereto. The scope that anyone skilled in the art may easily conceive changes and substitutions within the technical scope disclosed in the present disclosure that should be covered by the present disclosure. Therefore, the protection scope of the present disclosure should be subject to the scope of the claims as listed in the following.

Other embodiments of the disclosure will be apparent to those skilled in the art from consideration of the specification and practice of the disclosure provided herein. It is intended that the specification and examples be considered as exemplary only, with a true scope and spirit of the disclosure being indicated by the claims.

What is claimed is:

1. A method for outputting multimedia data, comprising:
outputting the multimedia data through a first device; and
responsive to detecting a posture change of a user, outputting the multimedia data through a second device,
wherein said posture change of the user results in the second device being in a closer proximity to the user than the first device.

2. The method according to claim 1, further comprising connecting the second device to the first device responsive to detecting said posture change of the user.

3. The method according to claim 1, wherein detecting said posture change of the user comprises detecting a distance between the first device and the user.

4. The method according to claim 1, wherein detecting said posture change of the user comprises detecting movement information of the first device.

5. The method according to claim 1, further comprising:
continue outputting the multimedia data through the first device, in the absence of detecting said posture change of the user.

6. The method according to claim 5, wherein the first device comprises a receiver and a speaker.

7. The method according to claim 5, wherein the second device comprises one of a Bluetooth speaker, a Bluetooth headset and an on-board Bluetooth play device with a Bluetooth connection with the first device.

8. The method according to claim 1, wherein said posture change of the user comprises a change of the user's posture in operating the first device.

9. The method according to claim 1, wherein said posture change of the user comprises an operation of the user on the first device.

10. The method according to claim 9, wherein the operation of the user on the first device includes at least one of clicking, double-clicking, sliding, or flipping of the first device.

11. A control device for outputting multimedia data, comprising:
a processor;
a sensor coupled to the processor, the sensor being configured to detect a posture change of a user,
wherein, responsive to detecting said posture change of the user, the processor is configured to control output of the multimedia data from through a first device to through a second device, wherein said posture change of the user results in the second device being in a closer proximity to the user than the first device.

12. The control device according to claim 11, wherein the processor is further configured to connect the second device to the first device, responsive to detecting said posture change of the user.

13. The control device according to claim 11, wherein the sensor is configured to detect a distance between the first device and the user.

14. The control device according to claim 11, wherein the sensor is configured to detect a movement information of the first device.

15. The control device according to claim 11, wherein the processor is further configured to continue outputting the multimedia data through the first device, in the absence of detecting said posture change of the user.

16. The control device according to claim 15, wherein the first device includes a receiver and a speaker.

17. The control device according to claim 13, wherein the sensor includes at least one of an infrared sensor, a light sensor, or a front camera, to detect the distance between the first device and the user.

18. The control device according to claim 14, wherein the sensor includes at least one of a gyroscope or an acceleration sensor to detect the movement information of the first device.

19. The control device according to claim 15, wherein the second device comprises one of a Bluetooth speaker, a Bluetooth headset and an on-board Bluetooth play device with a Bluetooth connection with the first device.

20. The control device according to claim 11, wherein said posture change of the user comprises a change of the user's posture in operating the first device.

21. The control device according to claim 11, wherein said posture change of the user comprises an operation of the user on the first device.

22. A computer-readable storage medium, the computer-readable storage medium storing computer-executable instructions for execution by a processor to implement the following method:
controlling a sensor to detect a posture change of a user; and
responsive to detecting said posture change of the user, controlling a processor to output multimedia data from through a first device to through a second device, wherein said posture change of the user results in the second device being in a closer proximity to the user than the first device.
